(19) United States
(12) Patent Application Publication
(10) Pub. No.: US 2025/0098688 A1
(43) Pub. Date: Mar. 27, 2025

(54) TRANSFER MECHANISM AND TRANSFER SYSTEM

(71) Applicant: ZIMPLISTIC PRIVATE LIMITED, Singapore (SG)

(72) Inventors: Pranoti Nagarkar ISRANI, Bangalore (IN); Rishi ISRANI, Bangalore (IN)

(73) Assignee: ZIMPLISTIC PRIVATE LIMITED, Singapore (SG)

(21) Appl. No.: 18/839,966

(22) PCT Filed: Feb. 21, 2023
(86) PCT No.: PCT/SG2023/050104

§ 371 Date: Aug. 20, 2024

(30) Foreign Application Priority Data
Feb. 21, 2022 (SG) 10202201690Y

(51) Int. Cl. A21C 11/00; F24C 7/04

(52) U.S. Cl. CPC A21C 11/004; F24C 7/043

(57) ABSTRACT

Disclosed is a transfer system. The transfer system comprises a transfer mechanism that itself comprises a first portion and second portion that together define a recess for receiving a dough ball. The transfer system also includes a drive system. The drive system drives the transfer mechanism to position the dough ball on a cooking surface, to make a flat edible, moves at least one of the first portion and second portion to open the recess to release the dough ball, and also drives the transfer mechanism to push the flat edible off the cooking surface.

### TECHNICAL FIELD

The present invention relates, in general terms, to a transfer system including a transfer mechanism for positioning a dough ball in a particular position on a cooking surface for cooking, to form a flat edible, and for pushing the flat edible off the cooking surface after cooking.

### BACKGROUND

In making a flat edible, it is typically necessary to form a dough ball, flatten the dough ball by rolling or pressing, and cook the dough ball to make a flat edible. For particular processes, it may also be necessary or desirable to char the flat edible after cooking.

Many current systems, such as commercial pizza ovens, include a conveyor that remains constantly in motion. An uncooked flat edible is placed on one end of the conveyor and progressively cooks as it moves to the opposite end of the conveyor. However, such systems are very large and are thus impractical for use in domestic kitchen.

An advantage of a conveyor-based system is that the user positions the flat edible in an appropriate—e.g. central—position on the conveyor. This avoids the flat edible touching the internal sides of the system. In automated systems for making flat edibles in a domestic setting, a dough ball is positioned in one location for flattening and cooking. However, the position of the dough ball inside the automated system can be inconsistent and lead to hangups whereby the flat edible or dough ball contacts the internal sides of the system, tearing the flat edible or otherwise leaving degrees such as crumbs that can burn in subsequent cooking cycles.

It would therefore be desirable to provide a system or mechanism that solves at least one of the above-described problems, or at least provides a useful alternative.

### SUMMARY

Transfer systems disclosed herein that enable a dough ball to be reliably positioned in a particular spot for cooking. The transfer mechanisms form part of the cooking system. After positioning the dough ball, the transfer mechanisms move out of the way to enable cooking to take place, and subsequently push the cooked flat edible out of the cooking system.

Some such transfer systems in accordance with the present disclosure comprise:
a transfer mechanism comprising a first portion and second portion that together define a recess for receiving a dough ball;
a drive system for:
   driving the transfer mechanism to position the dough ball on a cooking surface, to make a flat edible;
   moving at least one of the first portion and second portion to open the recess to release the dough ball; and
   driving the transfer mechanism to push the flat edible off the cooking surface.

The first portion and second portion may together define a body extending perpendicular to a direction of travel of the transfer mechanism.

The first portion and second portion may have a closed configuration for receiving the dough ball and an open configuration for releasing the dough ball, the first portion being spaced further from the second portion in the open configuration than in the closed configuration. A size of the recess may be adjustable by changing a relative position of the first portion and second portion when in the closed condition.

The recess may be frustoconical.

Surfaces of the first portion and second portion defining the recess may comprise one or more protrusions.

The first portion and second portion may be connected by a beam and the drive system drives the beam, thereby driving the transfer mechanism. The beam may extend across a rear side of the first portion and second portion, and a front side of at least one of the first portion and second portion pushes the flat edible off the cooking surface. The drive may drive the beam from one end of the beam, and an opposite end of the beam is received in a track. The track may comprise two opposed ends and the open towards one of said opposed ends, to facilitate removal of the beam from the track.

The drive system may be configured to drive the transfer mechanism in a first direction to position the dough ball on the cooking surface, in a second direction to move the transfer mechanism off the cooking surface after releasing the dough ball, and in the first direction to push the flat edible off the cooking surface.

The drive system may be a variable speed drive configured to drive the transfer mechanism at a first speed to position the dough ball on the cooking surface, and at a second speed to push the flat edible off the cooking surface, the second speed being lower than the first speed.

Also disclosed is a cooking system comprising:
a transfer system as described above; and
a charring system, the charring system comprising a gap through which light is emitted to char the flat edible,
   wherein the drive system is configured to stop the transfer mechanism from moving over the gap while pushing the flat edible off the cooking surface.

Advantageously, transfer mechanisms in accordance with embodiments of the present disclosure move a dough ball to a fixed position to undergo one or more cooking processes (such as pressing and roasting) and, after performance of the one or more cooking processes, move the now cooked flat edible away from the fixed position. This differs from conveyors that keep the food constantly in motion.

Advantageously, the frustoconical shape of embodiments of the recess ensure the dough ball is centred in the recess to enable accurate positioning of the dough ball on a cooking surface.

Advantageously, the protrusions or ribs in the recess reduce the amount of contact between the dough ball and the transfer mechanism. This reduces adhesion of the dough ball to the transfer mechanism and therefore makes release of the dough ball easier.

### BRIEF DESCRIPTION OF THE DRAWINGS

Embodiments of the present invention will now be described, by way of non-limiting example, with reference to the drawings in which:

FIG. 1 shows a partial internal schematic view of a cooking system comprising a transfer system in accordance with present teachings in a position to catch a dough ball;

FIG. 2 is a close-up view of the first and second portions of the transfer mechanism of FIG. 1 showing the recess, with frustoconical shape, defined by those portions;

FIG. 3 shows the partial internal schematic of an embodiment of a cooking system with the transfer mechanism having been driven to position the dough ball on a cooking surface of the cooking system;

FIG. 4 shows the partial internal schematic of FIG. 3 after the transfer mechanism has released the dough ball;

FIG. 5 shows an example position for the transfer mechanism during cooking of a flat edible and pushing of the cooked flat edible from the cooking system;

FIG. 6 is a partial internal schematic showing the transfer mechanism, kicker assembly and drive system;

FIG. 7 is a bottom view of the transfer mechanism; and

FIG. 8 is a partial internal schematic showing the transfer mechanism, kicker assembly, drive system and charring system.

### DETAILED DESCRIPTION

The description hereafter relates to transfer systems that reliably position a dough ball for cooking, for example such that the dough ball when flattened and then cooked does not encroach upon the sides of the cooking system in which it is being cooked. The description also relates to transfer systems that, after positioning the dough ball for cooking and moving out of the way to enable cooking to take place, come back against the cooked flat edible transfer it from the cooking system. In some embodiments, the transfer system includes a transfer mechanism that is adjustable to facilitate use with dough balls of various sizes.

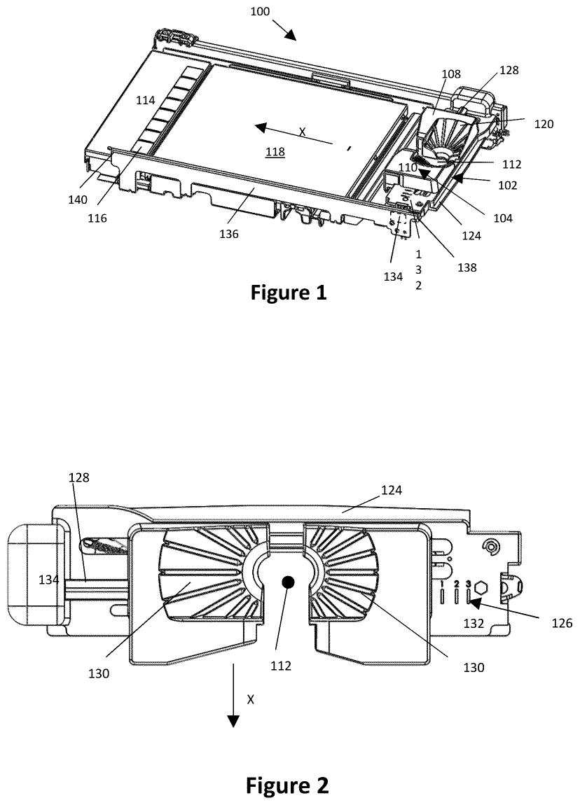

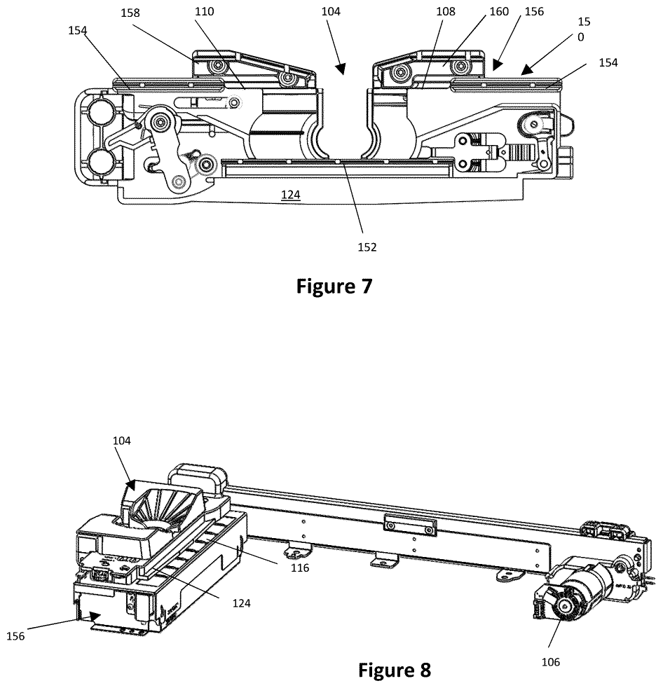

A cooking system 100 including such a transfer system 102 is shown in FIG. 1. The transfer system 102 includes a transfer mechanism 104 and a drive system 106 (as more easily seen in FIGS. 6 and 7. The transfer mechanism includes a first portion 108 and a second portion 110 that together define a recess 112 for receiving a dough ball.

When brought together in the configuration are shown in FIG. 1, the first portion 108 and the second portion 110 together define a body extending perpendicular to the direction of travel X of the transfer mechanism 104. That body is used to push a flat edible after cooking, out of the cooking system 100.

The present cooking system 100 includes a charring system 114 that has a gap 116 through which light passes to char the flat edible after cooking. In various embodiments, the gap is an absence of material in the form of a slot, a space or slot over which a grill extends to prevent a flat edible from entering the gap, or a section of translucent or transparent material through which light can pass from the charring system 114. Light of the strength to char the flat edible will generally be sufficiently hot that it will burn internal components of the system 100, including the transfer mechanism 104. To that end, the drive system 106 is configured to stop the transfer mechanism from moving over the gap while the transfer mechanism 104 is pushing the flat edible off the cooking surface generally designated 118. As context requires, the cooking surface 118 may be considered to stop at the gap 116 or at some point before the gap 116. Similarly, after depositing the dough ball onto the cooking surface, the transfer mechanism moves off the cooking surface. To that extent, the cooking surface is simply that part, or all, of surface 118 it is required to cook a particular flat edible-e.g. this may include or comprise all or part of a lower platen, the lower platen being a platen on which a dough ball rests before being pressed or roasted. Where cooking platens are used, the transfer mechanism is off the cooking surface if it is not between the platens during cooking of the flat edible.

In some embodiments, such as those where the charring light can be switched off exactly when the transfer mechanism 104 arrives at the gap 116, the transfer mechanism 104 may overlap the gap 116 partially or entirely, when pushing the flat edible from the system 100.

The transfer mechanism 104 is configured to catch a dough ball. The dough ball may not land exactly centrally in the recess 112. For example, if the dough ball is being dropped or rolled out of a mixing cup, it may not be in the exact bottom of the mixing cup. Even if the mixing cup is aligned with the recess 112, the dough ball in the mixing cup may not be so aligned.

To ensure the dough ball is positioned centrally in the recess 112, the recess includes a surface 120 that tapers towards the cooking surface 118. In the embodiment shown in FIG. 1, the recess 112 has a frustoconical shape. Other shapes of recess may be used as appropriate, for example a bowl shaped recess, or a through-hole with vertical sides relative to the cooking surface 118.

In addition, the surface 120 of recess 112 comprises one or more, and presently a plurality of, protrusions 130 (two of which are labelled in FIG. 2). The protrusions 130 reduce the contact area between the dough ball and transfer mechanism 104. In so doing, there is less likelihood that the dough ball will stick to the transfer mechanism 104 and either not be positioned exactly as desired on cooking surface 118, or travel with the transfer mechanism 104 when it moves out of the way to otherwise allow the dough ball to be flattened and cooked.

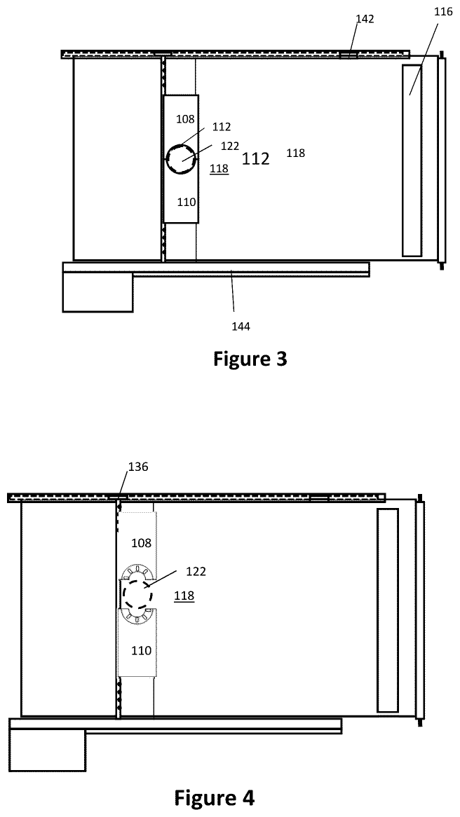

Once the dough ball is caught or otherwise positioned in the recess 112, the drive system drives the transfer mechanism 104 to position the dough ball on the cooking surface. With reference to FIG. 3, a dough ball 122 positioned in recess 112 is positioned on cooking surface 118 such that the dough ball 122 can be pressed or flattened to form the general shape of the flat edible, and then cooked to make the flat edible.

It will be appreciated, that in the configuration shown in FIG. 3 the dough ball 122 remains in the recess 112. So that the dough ball 122 can be deposited on the cooking surface 118 and the transfer mechanism 104 then removed from the cooking surface (in a direction opposite direction of travel X of FIG. 1) to facilitate flattening of the dough ball 122, the first portion 108 and second portion 110 have a closed configuration as shown in FIG. 1 for receiving the dough ball 122—e.g. from a mixing cup (not shown)—and an open configuration for releasing the dough ball as shown in FIG. 4.

The first portion 108 and second portion 110 are spaced further apart in the open configuration shown in FIG. 4 than in the closed configuration shown in FIG. 3. In the closed configuration, the first portion 108 and second portion 110 may be in abutment as shown in FIG. 3 or may be spaced apart. The portions 108, 110 may be spaced apart to adjust the size of the recess 112 when receiving the dough ball. To that end, the size of recess 112 is adjustable by changing the relative position of the first portion 108 and second portion 110 when in the closed configuration.

To adjust the size of the recess 112, one or both of the first portion 108 and second portion 110 may be movable to adjust the relative spacing therebetween when in the closed configuration shown in FIG. 1. To facilitate relocation of the first portion 108 and/or second portion 110 when in the closed configuration, the transfer mechanism 104 includes a beam 124 along which the relevant portion 108, 110 can be moved prior to receiving the dough ball.

The beam 124 or frame 132 comprises notches 126 (slots numbered “1”, “2” and “3” in FIG. 2) into which a corresponding protrusion (not shown) of respective portion 108, 110 is received to fix the relative position of portions 108 and 110 when in the closed condition. There may be only a single notch, or multiple notches. While the notches provide discrete steps for changing the size of the recess 112 in the closed condition, the transfer mechanism may instead be configured to provide continuous adjustment in any known manner.

To facilitate automatic movement of the portion 108 and 110 to the open configuration as shown in FIG. 4, it is generally desirable that the position of only one of portions 108, 110 is change to adjust the spacing therebetween and therefore adjust the size of recess 112 when in the closed configuration. The other portion 108, 110 can then be driven automatically by drive system 106 to open the recess 112 and thereby move the portions 108, 110 to the open condition. In the present embodiment, first portion 108 is movable to adjust the spacing between portion 108, 110, and thereby the size of recess 112, when in the closed configuration. Similarly, the second portion 110 is automatically movable by drive system 106 to move the portions 108, 110 to the open configuration to release the dough ball.

The drive system 106 is therefore configured to move at least one of the first portion 108 and second portion 110 to open the recess 112 to release the dough ball. To that end, the drive system 106 includes a drive for driving the second portion 110 along track 128 to move second portion 110 away from first portion 108 (e.g. to deposit a dough ball on the cooking surface), to move the transfer mechanism to the open condition, and to move second portion 110 towards first portion 108 to move the transfer mechanism to the closed condition.

The drive system may include drives on both sides of the transfer mechanism-i.e. at the top and bottom of FIG. 1. However, the present drive system 106 is positioned to one side of transfer mechanism 104. To enable the drive system 106 to drive the transfer mechanism 104, the first portion and second portion are connected by beam 124, and the drive system 106 drives the beam 124. Presently, beam 124, together with support 132, form a frame for maintaining control of the positions of portions 108 and 110.

The beam 124 extends across a rear side (with respect to direction of travel X) of the first portion 108 and second portion 110. A front side one or both of first portion 108 and second portion 110 is then used to push the flat edible off the cooking surface 118 after cooking.

To maintain alignment of the transfer mechanism 104 with the direction of travel, an end 134 of the beam 124 is a head that is received in or on track 136. The track guides motion of the head 134, and thereby the beam 124 and transfer mechanism 104, such that the transfer mechanism 104 remains substantially perpendicular to the direction of travel X.

The track 136 comprises a slot in which the head 134 is received in a known manner, as shown in FIG. 6. To facilitate removal of the transfer mechanism 104, e.g. for cleaning or maintenance, the track 136 comprises two opposed ends 138, 140 and may be open (e.g. as illustrated at point 142 of FIG. 3) towards one of the opposed ends 138, 140. The head 134 can be readily lifted out of the track 136 at the opening 142. The transfer mechanism 104 is also attached to the drive system 106 by a magnetic coupling that can be readily disconnected by a small manual force to remove the transfer mechanism 104. In view of present teachings, the skilled person will understand that any suitable connection system may be used.

The drive system 106 also includes a track 144, such as a caterpillar track or tape/strap, with the transfer mechanism 104 connected to the track 144 such that rotation of the wheel to drive the track 144 will result in the transfer mechanism 104 moving along the track 144.

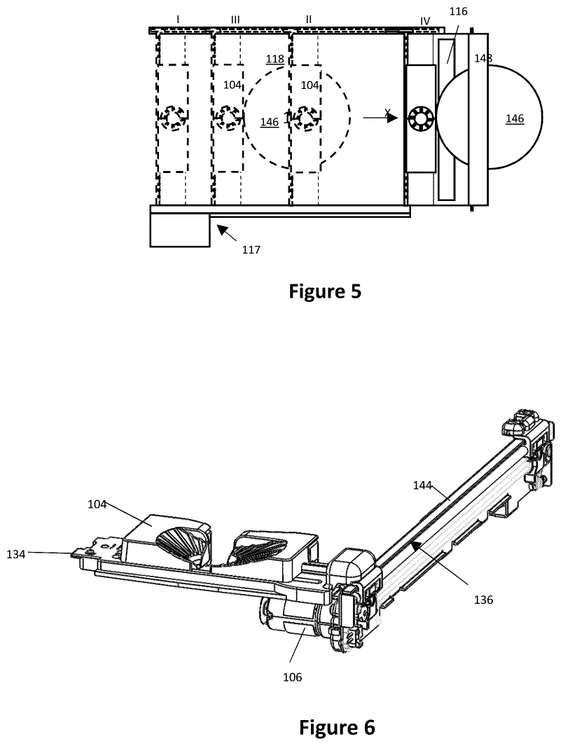

With reference to FIG. 5, the drive system 106 is also configured to drive the transfer mechanism 104 to push the flat edible 146 off the cooking surface 118. Thus, FIG. 5 shows various stages in the process for cooking a flat edible. In particular, the transfer mechanism 104 starts at position I when receiving a dough ball. The drive system 117 (which, in this embodiment is located on the opposite side of the track 144 when compared with the drive system 106 of FIG. 1) then drives the transfer mechanism 104 to position II (i.e. opposite to direction of travel X), and moves the transfer mechanism 104 to the open condition to release the dough ball. The drive system 117 moves the transfer mechanism 104 back to position I in the open condition, and the drive system 117 moves the transfer mechanism 104 to the closed condition. A cooking assembly of the cooking system 100 then presses the dough ball into the shape indicated by reference numeral 146, being a flat edible, and cooks the pressed dough ball to form a flat edible. The drive system 106 then moves the transfer mechanism 104 in the direction of travel X to position III against a rear side of the flat edible 146 and pushes the flat edible in the direction of travel X until the transfer mechanism 104 reaches position IV. At this point the flat edible 146 pushes open door or flap 148, and leaves the cooking system 100 under gravity. The drive system 106 may be a single speed drive. However, various processes can occur at different speeds. Presently, drive system 106 is a variable speed drive having at least a first speed to position the dough ball on the cooking surface 118, and a second speed to push the flat edible 146 off the cooking surface 118. The second speed is lower than the first speed. Moreover, the present cooking system 100 includes a charring system. Thus the drive system 106 stops forward travel of the transfer mechanism 104 in the direction of travel X before or when the transfer mechanism 104 reaches gap 116 through which light from the charring system reflects to char a bottom side of the flat edible 146. Incidentally, the charring system may also include an upper charring lamp that emits light directed downwardly onto a top surface of the flat edible 146 to char that top surface.

FIG. 6 illustrates a transfer system including a transfer mechanism and drive system. In this embodiment, the flat body comprising the cooking system may extend between the transfer mechanism 104 and motor or drive system 106.

FIG. 7 shows an underside of the transfer mechanism 104. In this embodiment, the transfer mechanism 104 includes a cleaning member 150. As the transfer mechanism 104 travels across the cooking surface 118 and/or over gap 116, the cleaning member 150 sweeps, scrapes or otherwise moves residue from the cooking process off the cooking surface or gap 116. To that end, the cleaning member 150 is effective for cleaning debris of a gap that is occupied by translucent or transparent material such as glass. The present cleaning member 150 comprises a brush. The brush is formed in three portions 152, 154. The portions 152, 154 of the cleaning member 150 extend at least part way across the cooking surface 118 as a transfer mechanism 104 moves across the cooking surface 118. In the present embodiment, the brush, or portions 152, 154, together extend the full width of the cooking surface 118.

The cleaning member 150 is located at a front edge 156 of the members 108, 110 of the transfer mechanism 104. The transfer mechanism 104 may travel sufficiently far to open door 148 (shown in FIG. 5) and push debris from portions 154 through the door 148 and out of the cooking system 100. The cleaning member 150 should move at least sufficiently far in the direction of travel X such that portion 152 pushes debris off gap 116. This will ensure that the charring process does not burn debris that would otherwise have remained on any transparent or translucent plate occupying the gap 116.

Also located along the front edge 156 is a weight assembly. The weight assembly may comprise a single weight but presently comprises a pair of weights 158, 160. The weight assembly maintains contact between the transfer mechanism 104 and the cooking surface 118. This is particularly important if the cooking surface warps over time or its non-stick surface becomes less effective. Either of these situations may lead to the flat edible being torn while being pushed out of the cooking system. The weights 158, 160 may be attached to, or sit on, the front edge 156 by any appropriate means, or may be housed internally of members 108, 110.

FIG. 8 shows a transfer mechanism 104 with trailing or rear edge, beam 124, having moved to the far edge of the gap 116 in a direction of travel X.

Accordingly, the cleaning member 150 has moved to all past that far edge, resulting in debris either being pushed out of the cooking system or at least off the gap 116. The gap 116 forms part of the charring module 156 that also includes a charring lamp and other components necessary to char the lower surface of the flat edible as the flat edible transitions from the cooking system 100.

It will be appreciated that many further modifications and permutations of various aspects of the described embodiments are possible. Accordingly, the described aspects are intended to embrace all such alterations, modifications, and variations that fall within the spirit and scope of the appended claims or statements.

Throughout this specification and the claims or statements which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A transfer system comprising:
a transfer mechanism comprising a first portion and second portion that together define a recess for receiving a dough ball;
a drive system for:
driving the transfer mechanism to position the dough ball on a cooking surface, to make a flat edible;
moving at least one of the first portion and second portion to open the recess to release the dough ball; and
driving the transfer mechanism to push the flat edible off the cooking surface.

2. The transfer system of claim 1, when the first portion and second portion together define a body extending perpendicular to a direction of travel of the transfer mechanism.

3. The transfer system of claim 2, wherein the first portion and second portion have a closed configuration for receiving the dough ball and an open configuration for releasing the dough ball, the first portion being spaced further from the second portion in the open configuration than in the closed configuration.

4. The transfer system of claim 3, wherein a size of the recess is adjustable by changing a relative position of the first portion and second portion when in the closed condition.

5. The transfer system of claim 1, wherein the recess is frustoconical.

6. The transfer system of claim 1, wherein surfaces of the first portion and second portion defining the recess comprise one or more protrusions.

7. The transfer system of claim 1, wherein the first portion and second portion are connected by a beam and the drive system drives the beam, thereby driving the transfer mechanism.

8. The transfer system of claim 7, wherein the beam extends across a rear side of the first portion and second portion, and a front side of at least one of the first portion and second portion pushes the flat edible off the cooking surface.

9. The transfer system of claim 7, wherein the drive drives the beam from one end of the beam, and an opposite end of the beam is received in a track.

10. The transfer system of claim 9, wherein the track comprises two opposed ends and is open towards one of said opposed ends, to facilitate removal of the beam from the track.

11. The transfer system of claim 1, wherein the drive system is configured to drive the transfer mechanism in a first direction to position the dough ball on the cooking surface, in a second direction to move the transfer mechanism off the cooking surface after releasing the dough ball, and in the first direction to push the flat edible off the cooking surface.

12. The transfer system of claim 1, wherein the drive system is a variable speed drive configured to drive the transfer mechanism at a first speed to position the dough ball on the cooking surface, and at a second speed to push the flat edible off the cooking surface, the second speed being lower than the first speed.

13. A cooking system comprising:
a transfer system according to claim 1; and
a charring system, the charring system comprising a gap through which light is emitted to char the flat edible,
wherein the drive system is configured to stop the transfer mechanism from moving over the gap while pushing the flat edible off the cooking surface.
